(19) United States
(12) Patent Application Publication
(10) Pub. No.: US 2007/0217784 A1
(43) Pub. Date: Sep. 20, 2007

(54) Picture-Taking Unit

(76) Inventors: Hideaki Kaneiwa, Kanagawa (JP); Ryuji Shinohara, Kanagawa (JP); Atsushi Matsunaga, Kanagawa (JP); Yoshio Ishii, Kanagawa (JP)

Correspondence Address: SUGHRUE-265550, 2100 PENNSYLVANIA AVE. NW, WASHINGTON, DC, 20037-3213, US

(21) Appl. No.: 11/579,766

(22) PCT Filed: May 12, 2005
(86) PCT No.: PCT/JP05/08692

§ 371 Date: Nov. 7, 2006

(30) Foreign Application Priority Data
May 14, 2004 (JP) 2004-144857

(51) Int. Cl. G03B 9/02; G02F 1/00

(52) U.S. Cl. 396/506

(57) ABSTRACT

There is provided a picture-taking unit using an automatic transmitted-light control system which is wide in range of controllable light quantity, reduced in loss of transmitted light by the system itself and fast in response speed. The picture-taking unit is configured so as to have a light control device using an electrochromic material on the subject side or the imaging recording medium side of a taking lens thereof.

### TECHNICAL FIELD

The present invention relates to a picture-taking unit that has a light control device using an electrochromic material.

### BACKGROUND ART

Devices that modify optical densities in response to electromagnetic waves have broad applicability. As materials capable of altering their optical densities in response to electromagnetic waves, namely materials having the function of controlling transmission or reflection of light, photochromic materials and electrochromic materials are known.

The term “photochromic materials” refers to the materials that alter their optical densities when irradiated with light, and are being applied to sunglasses, UV checkers, materials related to graphic arts, fiber-processed goods and so on.

The term “electrochromic materials” refers to the materials that alter their optical densities when undergo inflow or outflow of electrons, and are being applied to antiglare mirrors for automobiles, window materials for vehicles and so on.

Uses of those optical density-altering materials include cameras and other units for taking photographs. For instance, film-with-lens units as camera units that eliminate trouble of loading films and permit taking of photographs immediately after purchases have come into widespread use in recent years because of their simplicity and convenience. In order to increase their utility, it is being carried out to mount high-speed films. However, a film with lens hitherto used, which features simplicity and convenience, has never equipped with mechanism for exposure adjustment. Therefore, bright-atmosphere shooting with high-speed-film-loaded films with lens resulted in whitish washed-out pictures because of too much exposure, and cases frequently occurred where the shooting ended in failure. So the AE control systems utilizing photometry during the shooting have been introduced, and films with lens permitting automatic switching of an aperture according to shooting light quantity have come on the market. By these cameras, the frequency of occurring of shooting failures by a profusion of exposure amounts has been significantly reduced.

Films with lens utilizing the aforementioned photochromic materials as elements for simply and cheaply providing “a light control filter” that enables the control of quantities of light incident on a photosensitive material according to quantities of light for shooting have been put forth (See, e.g., Patent Document 1, Patent Document 2, Patent Document 3 and Patent Document 4). To mention more specifically, the photochromic materials are materials having properties of generating colors by irradiation with light of specific wavelengths, namely increasing their optical densities, and discoloring by stop of the light irradiation, or by heating, or by irradiation with light of different wavelengths, namely decreasing their optical densities, and inorganic compounds containing silver halide and some organic compounds are known as such materials. It has been thought that the light control becomes possible by placing a filter made from a photochromic material on the optical axis and causing the filter to generate color or to discolor according to the quantities of incident light.

However, the time required for photochromic materials to generate colors is generally of the order of 1 minute and the time required for them to discolor is generally more than several tens of minutes (See, e.g., Non-patent Document 1), so those materials are difficult to use in control systems of light for shooting.

In contrast to those materials, the aforementioned electrochromic materials can be given as examples of materials capable of generating colors and discoloring at higher speeds. To mention more specifically, the electrochromic materials are materials having properties of increasing their optical densities when undergo inflow or outflow of electrons by voltage applied thereto and decreasing their optical densities when there occurs electron transfer opposite to the flow of electrons at the time of an increase in optical density, and it is known that some metal oxides and organic compounds have such properties.

Patent Document 1: JP-A-5-142700

Patent Document 2: JP-A-6-317815

Patent Document 3: JP-A-11-352642

Patent Document 4: JP-A-2001-13301

Non-patent Document 1: Solid State and Material Science, volume 6, page 291 (1990)

### DISCLOSURE OF THE INVENTION

### Problems that the Invention is to Solve

For picture-taking units such as films with lens, as mentioned above, systems that permit shooting in ranges from high to low brightness, or systems having the so-called wide shooting range, have been desired. In order to realize such systems, it is necessary first to increase the system sensitivity of a picture-taking unit by use of film with a high speed of ISO 400 or above so as to ensure shooting in the low-brightness range. Since many of the simple picture-taking systems like films with lens have fixed shutter speeds and apertures, there occur troubles that increases in system sensitivity result in overexposure in high-brightness ranges. So it is desirable to create systems causing no overexposure in high brightness ranges even when the system sensitivity is in a high state.

The present invention aims to provide a picture-taking unit using an automatic transmitted-light control system which is wide in range of controllable light quantity, reduced in loss of transmitted light by the system itself and fast in response speed.

### Means for Solving the Problems

The foregoing problem can be solved by reducing quantities of light incident on an imaging recording medium loaded in a picture-taking unit through the placement of an electrochromic material-utilized light control device on the outside of a taking lens (on the subject side of the lens) or on the inside of a taking lens (on the imaging recording medium side of the lens).

More specifically, an embodiment of the present invention is a picture-taking unit comprising: a taking lens; and a light control device using an electrochromic material, on a subject side of the taking lens.

Another embodiment of the present invention is a picture-taking unit comprising a taking lens; and a light control device using an electrochromic material, on an imaging recording medium side of the taking lens. Still another embodiment of the present invention is a picture-taking unit, further comprising a shutter on the imaging recording medium side of the taking lens, wherein the picture-taking unit comprises the light control device on the imaging recording medium side of the shutter.

A further embodiment of the present invention is a picture-taking unit, wherein the aforesaid light control device comprises a nanoporous semiconductor material to which an electrochromic material is adsorbed.

A still further embodiment of the present invention is a picture-taking unit, wherein the aforesaid light control device has an optical density of 0.2 or below at a wavelength of 400 nm when it is in a discolored state.

Another embodiment of the present invention is a picture-taking unit, wherein an average value of optical densities at wavelengths of 400 to 500 nm, an average value of optical densities at wavelengths of 500 to 600 nm and an average value of optical densities at wavelengths of 600 to 700 nm that the aforesaid light control device has in a discolored state are all 0.1 or below.

Still another embodiment of the present invention is a picture-taking unit, which is a film with lens.

A further embodiment of the present invention is a picture-taking unit, which is loaded with film having a high speed of IS0400 or above.

### Advantage of the Invention

In accordance with the present invention, a light control device using an electrochromic material that can generate electromotive force in response to the illuminance of ultraviolet light, visible light or the like is placed on the outside of a lens (the subject side of a lens) or on the inside of a lens (the imaging recording medium side of a lens) mounted in a picture-taking unit such as a film with lens, a still-video camera or a camera phone, thereby achieving extension of shooting-capable illuminance range.

### BRIEF DESCRIPTION OF THE DRAWINGS

FIG. 1 is a schematic cross-sectional diagram showing an exemplary structure of an optical density-altering element according to the invention.

FIG. 2(a) is a schematic cross-sectional diagram of a chief part of a film with lens having an optical device according to the invention, which represents a case of having a light control device on the subject side of a picture-taking lens.

FIG. 2(b) is a schematic cross-sectional diagram of a chief part of a film with lens having an optical device according to the invention, which represents a case of having a light control device on the imaging recording medium side of a picture-taking lens.

FIG. 3 is an external view of an example of a film with lens having an optical device according to the invention.

FIG. 4 is a schematic cross-sectional diagram showing a structure of an example of an optical density-altering element (a light control filter) according to the invention.

FIG. 5 is a graph showing an electromotive-force response characteristic of the solar cell used in Example 1.

FIG. 6 is a graph showing an electromotive-force response characteristic of the light control filter made in Example 1.

FIG. 7 is a graph showing an electromotive-force response characteristic of the optical device made according to the invention in Example 1.

FIG. 8 is a schematic cross-sectional diagram of a chief part of a still-video camera with an optical device according to the invention.

FIG. 9 is an external view of an example of a still-video camera with an optical device according to the invention.

### DESCRIPTION OF REFERENCE NUMERALS AND SIGNS

1 Film with lens camera unit

4 Picture-taking lens

5 Viewfinder

6 Electronic flash-emitting section

8 Shutter button

13 Solar cell

16 Photographic film

18 Light-shielding tube

20 Lens holder

21 Aperture

22 Exposure opening

23 Light control filter

24 Aperture-Stop

29 Optical axis

31 Support

32 Conductive coating

33a, b Electrochromic material-adsorbed metal oxide layer

34 Electrolyte

35 Spacer

### BEST MODE FOR CARRYING OUT THE INVENTION

The invention is further described below in detail.

The term “optical density” in the invention is defined as the value A calculated from the following equation (1):
A=−log(I_{T}/I₀) Equation (1)
where I₀ is the intensity of light incident on an optical density-altering element and I_{T} is the intensity of the light transmitted by the element.

The term “nanoporous material” in the invention refers to the material increased in surface area by forming asperities with sizes on the order of nanometers so that substances can be adsorbed in higher amounts to its surface. The degree to which the surface is made porous is represented by “roughness factor”.

The expression “roughness factor of a nanoporous semiconductive material” in the invention mean the ratio of a practically effective surface area of a semiconductive material layer concerned to an area of the plane on which the surface of the semiconductive material layer is projected. Specifically, the roughness factor can be determined by BET method.

The expression “discolored state” in the invention indicates the case where the optical density of an optical density-altering element is placed under the lowest possible state, e.g., by shorting across the optical density-altering element or placing a reverse voltage between both poles of an optical density-altering element, namely applying a voltage opposite in polarity to the voltage applied at the time of color generation.

The term “semiconductive material” in the invention follows a common definition thereof. According to, e.g., Butsurigaku Jiten (which might be translated “Dictionary of Physics”), published by Baifukan Co., Ltd., the term semiconductive material refers to a material whose electric resistance is intermediate between those of metal and insulator.

The expression “adsorption of an electrochromic material to a nanoporous semiconductive material” in the invention refers to a phenomenon in which an electrochromic material becomes attached to the surface of a nanoporous semiconductive material through chemical bonding or physical bonding, and the definition of adsorption follows a common definition. The adsorption of an electrochromic material to a nanoporous semiconductive material can be detected, e.g., by the method as mentioned below.

A nanoporous semiconductive material supposed to have adsorbed an electrochromic material is immersed in a 0.1M solution of NaOH, and shaken for 3 hours at 40° C. The amount of the solution used herein is determined by the application quantity of the nanoporous semiconductive material, and it is appropriate to use 0.5 ml of the solution per 1 g/m² of application quantity. The absorption spectrum of the solution after shaking is measured with a spectrophotometer. When an absorption band of the electrochromic material used is detected as a result of measuring and the absorbance at the peak of the absorption band is 0.01 or above, the electrochromic material is regarded as “having been adsorbed” to the nanoporous semiconductive material. Additionally, the determination of what kind (NaOH in the above case), concentration and shaking temperature and time of an immersion solution are adopted in the above measurement is based on the species of a nanoporous semiconductive material used and an electrochromic material used, so conditions for the adsorption detection are not limited to the foregoing ones.

The term “electromagnetic wave” in the invention follows a common definition thereof. According to, e.g., Butsurigaku Jiten (published by Baifukan Co., Ltd.), electric and magnetic fields each include a static field remaining invariant without depending on time and a wave field varying with time and propagating into a far distant space, and these wave fields are defined as the electromagnetic wave. More specifically, electromagnetic waves are classified under the following groups: γ rays, X rays, ultraviolet rays, visible rays, infrared rays and radio waves. And all of them are included in the electromagnetic waves at which the invention is targeted. However, in the case of utilizing the optical device according to the invention as a light control system of a camera unit, the electromagnetic waves made the target in particular are preferably ultraviolet rays, visible rays and infrared rays, far preferably ultraviolet rays and visible rays.

The optical device according to the invention has an electromotive-force generation element that generates an electromotive force by absorption of electromagnetic waves and an optical density-altering element that alters its optical density under the action of the electromotive force, and can function as a light control device capable of modifying the quantity of transmitted light according to the intensity of electromagnetic waves since the optical-density variations in the optical density-altering element take place in response to variations in electromotive force, or electromagnetic waves, generated from the electromotive-force generation element.

Components of the optical device according to the invention are each described below.

The expression “an element that generates an electromotive force (an electromotive-force generation element)” in the invention refers to an element that converts electromagnetic waves into electric energy. More specifically, such an element is typified by solar cells for converting sunbeams into electric energy. Examples of a material constituting a solar cell include monocryatalline silicon, polycrystalline silicon, amorphous silicon, and compounds such as cadmium telluride and indium copper selenide. Solar cells for use in an optical device according to the invention can be chosen from among known solar cells using those compounds so as to fit for the intended use of the optical device.

In addition, the techniques of photoelectric transducers using dye-sensitized oxide semiconductors (hereinafter abbreviated as “dye-sensitized photoelectric transducers) and photoelectrochemical cells using such transducers, which are described, e.g., in Nature, volume 353, pages 737-740 (1991), U.S. Pat. No. 4,927,721 and JP-A-2002-75443, can be utilized for making electromotive-force generation elements according to the invention. Such dye-sensitized photoelectric transducers are also suitable as electromotive-force generation elements according to the invention.

Alternatively, an electromagnetic-wave sensor and a voltage source may be combined into an electromotive-force generation element. The electromagnetic-wave sensor usable therein is not limited to particular ones, but may include a phototransistor, a CdS sensor, a photodiode, CCD, CMOS, NMOS and a solar cell. Materials for an electromagnetic-wave sensor can be chosen appropriately with reference to the wavelengths of electromagnetic waves to which the sensor is desired to respond. The voltage source is not limited to particular ones, but may include a dry cell, a lead-acid battery, a diesel electric power generator and an aerogenerator. The dry cell usable herein may be either a primary battery such as an alkaline dry battery or a manganese dry battery, or a secondary battery such as a nickel-cadmium battery, a nickel metal hydride battery or a lithium-ion battery.

Examples of an electromotive-force generation element preferred in the invention include a solar cell made from monocrystalline silicon, polycrystalline silicon or amorphous silicon, a dye-sensitized photoelectric transducer, and a combination of a phototransistor and a dry cell. When an optical device according to the invention is applied in a camera unit, it is preferable that the electromotive-force generation element generates an electromotive force of strength proportional to the intensity of irradiated electromagnetic waves (notably sunbeams).

The expression “an element that alters its optical density (optical density-altering element)” in the invention refers to an element capable of altering its optical density under the action of an electromotive force generated by an electromotive-force generation element, namely electric energy, and modifying transmittances of electromagnetic waves incident thereon.

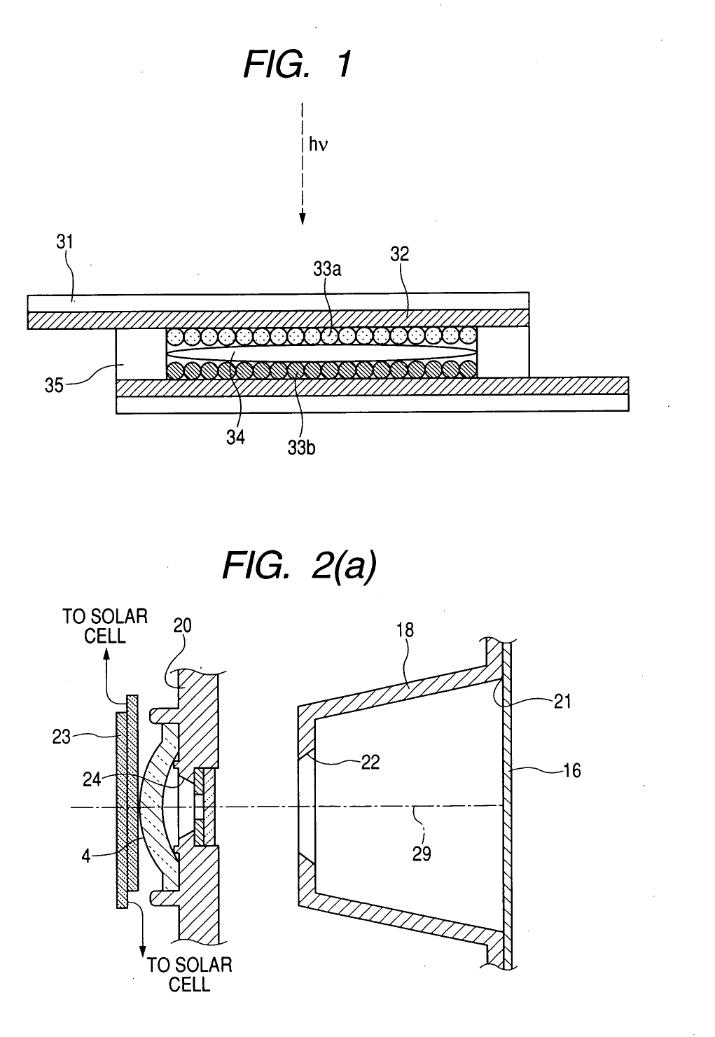

The optical density-altering element has a semiconductive material to which a material whose optical density varies with electric energy applied thereto (an electrochromic material) is adsorbed, and further components making up the optical density-altering element include a conductive coating-applied support and an electrolyte having charge of conductivity in the interior of the element. A representative example of the makeup of the optical density-altering element is shown in FIG. 1. As shown in FIG. 1, electrochromic materials are adsorbed to semiconductive materials that have been made porous (33a, 33b) The optical densities of electrochromic materials vary with electric energies supplied from the upper conductive coating and the lower conductive coating, respectively. An incident electromagnetic wave hν is absorbed by the electrochromic materials in response to variations in optical densities of the electrochromic materials, and thereby the quantity of the transmitted electromagnetic wave is modified. A form of the optical density-altering element is not limited to the form as shown in FIG. 1, but the element can have a wide variety of forms according to its uses. Examples of a form the element can take include forms of an optical filter, a lens, a diaphragm, a mirror, a window, glasses and a display panel. In a camera unit, the form of the optical density-altering element is preferably an optical filter, a lens or a diaphragm.

A support as a constituent of the optical density-altering element has no particular restriction, but examples of its material may include glass, plastic, polyethylene terephthalate (PET), polyethylene naphthalate (PEN), triacetyl cellulose (TAC), polycarbonate (PC), polysulfone, polyether sulfone (PES), polyether ether ketone, polyphenylene sulfide, polyarylate (PAR), polyamide, polyimide (PIM), polystyrene, norbornene resin (ARTON), acrylic resin, and polymethyl methacrylate. From these materials, the support material can be chosen appropriately according to its use and form. Herein, it is preferable to choose a material showing poor absorption of the electromagnetic waves at which the optical device according to the invention is targeted, and glass, PET, PEN, TAC or acrylic resin is especially suitable for light with wavelengths (λ) ranging from 400 nm to 700 nm. In addition, it is preferable that an antireflective layer (e.g., a thin layer of silicon oxide) is provided on the support surface with the intention of avoiding a loss of transmitted light due to reflection from the support surface. Moreover, various functional layers, such as an impact absorption layer for protecting the device from impact, an abrasion-resistant layer for avoiding damage to the device by friction and an electromagnetic-wave absorbing layer for permitting a cutoff of electromagnetic waves outside the target of the invention (e.g., ultraviolet light in the optical device for visible light), may be provided on the support surface.

An electrical conduction layer as a constituent of the optical density-altering element is not limited to particular ones, but examples thereof may include thin metallic films (thin films of gold, silver, copper, palladium, tungsten and alloys of two or more thereof), films of oxide semiconductors (tin oxide, silver oxide, zinc oxide, vanadium oxide, ITO (tin oxide-doped indium oxide), antimony-doped tin oxide (ATO), FTO (fluorine-doped tin oxide), AZO (aluminum-doped zinc oxide)), thin films of conductive nitrides (titanium nitride, zirconium nitride, hafnium nitride), thin films of conductive borides (LaB₆), compounds with Spinel structure (MgInO₄, CaGaO₄), conductive polymer films (polypyrrole/FeCl₃), ionic conductive films (polyethylene oxide/LiClO₄), and inorganic-organic complex films (finely powdered indium oxide/saturated polyester resin). It is preferable to choose a material showing poor absorption of the electromagnetic waves at which the optical device according to the invention is targeted, and tin oxide, FTO and ITO are especially suitable for light with wavelengths (X) ranging from 400 nm to 700 nm. In order to further reduce absorption of target electromagnetic waves, it is appropriate that the electrical conduction layer be made as thin as possible so far as it can ensure the desired conductivity. More specifically, the thickness of the electrical conduction layer is preferably 1,000 nm or below, far preferably 200 nm or below, particularly preferably 100 nm or below.

Examples of a semiconductive material as a constituent of the optical density-altering element, though not particularly limited to the materials given below, include the metal oxides, metal sulfide and metal nitrides as recited below.

Examples of metal oxide, though not particularly limited to the oxides as recited below, include titanium oxide, zinc oxide, silicon oxide, lead oxide, tungsten oxide, tin oxide, indium oxide, niobium oxide, cadmium oxide, bismuth oxide, aluminum oxide, ferrous oxide and compound oxides formed from the oxides recited above, and further those oxides doped with fluorine, chlorine, antimony, phosphorus, arsenic, boron, aluminum, indium, gallium, silicon, germanium, titanium, zirconium, hafnium or tin. Alternatively, the metal oxide used as a semiconductive material may be titanium oxide having the surface coated with ITO, antimony-doped tin oxide or FTO.

Examples of metal sulfide, though not particularly limited to the sulfides as recited below, include zinc sulfide, cadmium sulfide, compound sulfide formed from these sulfides, and these sulfides doped with aluminum, gallium or indium. Alternatively, such metal sulfides may be coated on other materials.

Examples of a metal nitride layer, though not particularly limited to those recited below, include aluminum nitride, gallium nitride, indium nitride and compound nitrides formed from these nitrides, and further those nitrides doped with small amounts of different atoms (tin, germanium, etc.). Alternatively, such metal nitrides may be coated on other materials. It is preferable to choose a semiconductive material showing poor absorption of the electromagnetic waves at which the optical device according to the invention is targeted, and titanium oxide, tin oxide, zinc oxide, zinc sulfide and gallium nitride are suitable for light with wavelengths (λ) ranging from 400 nm to 700 nm. Of these materials, tin oxide and zinc oxide in particular are preferred.

In the invention, smooth inflow/outflow of electrons into/from an electrochromic material can be achieved by making the electrochromic material absorb to such a semiconductive material, and enables the optical density-altering element to alter its optical density in a short time. Herein, the intenser color generation becomes possible when the greater amount of electrochromic material is adsorbed to the semiconductive material. In order to enable the electrochromic material to adsorb in a greater amount, the semiconductive material is made nanoporous to increase its surface area, and the roughness factor thereof is adjusted preferably to 20 or above, particularly preferably to 150 or above.

As a method of forming such a porous material, mention may be made of the method of binding superfine particles on the order of nanometer. In this case, the transmitted-light loss resulting from absorption or scattering of electromagnetic waves by a semiconductive material can be minimized by optimizing sizes and size distribution of particles used. The sizes of particles used are preferably 100 nm or below, far preferably from 1 nm to 60 nm, further preferably from 2 nm t 40 nm. In addition, it is preferable that the distribution of these sizes is monodisperse, if possible. In addition, the response speed of the present optical device can be accelerated by optimizing the particle sizes and the distribution thereof.

In the invention, two or more layers made of these electrochromic material-adsorbed semiconductive materials may be used. The layers used may have the same composition, or different compositions. The electrochromic material-adsorbed semiconductive material and the electrochromic material-free semiconductive material may be used in combination.

Examples of an electrochromic material as a constituent of the optical density-altering element include organic dyes, such as viologen dyes, phenothiazine dyes, styryl dyes, ferrocene dyes, anthraquinone dyes, pyrazoline dyes, fluoran dyes and phthalocyanine dyes; conductive high polymers, such as polystyrene, polythiophene, polyaniline, polypyrrole, polybenzin and polyisothianaphthene; and inorganic compounds, such as tungsten oxide, iridium oxide, nickel oxide, cobalt oxide, vanadium oxide, molybdenum oxide, titanium oxide, indium oxide, chromium oxide, manganese oxide, prussian blue, indium nitride, tin nitride and zirconium nitride chloride.

When a specific moiety of an organic compound is named “group” in the invention, the “group” may include not only the case where the moiety itself has no substituent, but also cases where the moiety has at least one substituent (up to the greatest possible number of substituents). So, the term “alkyl group”, for example, refers to a substituted alkyl group or an unsubstituted alkyl group.

When such a substituent is symbolized by W, the substituent W has no particular restrictions, but examples thereof include halogen atoms, alkyl groups (including cycloalkyl groups, bicycloalkyl groups and tricycloalkyl groups), alkenyl groups (including cycloalkenyl groups and bicycloalkenyl groups), alkynyl groups, aryl groups, heterocyclic groups (which may be referred to as hetero-ring groups), a cyano group, a hydroxyl group, a nitro group, a carboxyl group, alkoxy groups, aryloxy groups, silyloxy groups, heterocyclyloxy groups, acyloxy groups, carbamoyloxy groups, alkoxycarbonyloxy groups, aryloxycarbonyloxy groups, amino groups (including alkylamino groups, arylamino groups and heterocyclylamino groups), an ammonio group, acylamino groups, aminocarbonylamino groups, alkoxycarbonylamino groups, aryloxycarbonylamino groups, sulfamoylamino groups, alkyl- and arylsulfonylamino groups, a mercapto group, alkylthio groups, arylthio groups, heterocyclylthio groups, sulfamoyl groups, a sulfo group, alkyl- and arylsulfinyl groups, alkyl- and arylsulfonyl groups, acyl groups, aryloxycarbonyl groups, alkoxycarbonyl groups, carbamoyl groups, aryl- and heterocyclylazo groups, imido groups, phosphino groups, a phosphinyl group, a phosphinyloxy group, phosphinylamino groups, a phosphono group, silyl groups, hydrazino groups, ureido groups, aboronic acid group (—B(OH)₂), aphosphato group (—OPO(OH)₂), a sulfato group (—OSO₃H), and known other substituents.

In addition, two Ws can jointly form a ring (such as an aromatic or non-aromatic hydrocarbon ring, or a heterocyclic ring, which may further be combined with another ring to form a polycyclic fused ring. Examples thereof include a benzene ring, a naphthalene ring, an anthracene ring, a phenanthrene ring, a fluorene ring, a triphenylene ring, a naphthacene ring, a biphenyl ring, a pyrrole ring, a furan ring, a thiophene ring, an imidazole ring, an oxazole ring, a thiazole ring, a pyridine ring, a pyrazine ring, a pyrimidine ring, a pyridazine ring, an indolizine ring, an indole ring, a benzofuran ring, a benzothiophene ring, an isobenzofuran ring, a quinolizine ring, a quinoline ring, a phthalazine ring, a naphthyridine ring, a quinoxaline ring, a quinoxazoline ring, an isoquinoline ring, a carbazole ring, a phenanthridine ring, an acridine ring, aphenanthroline ring, a thianthrene ring, a chromene ring, a xanthene ring, a phenoxanthine ring, a phenothiazine ring and a phenazine ring).

Of the substituents recited above as Ws, those having hydrogen atoms may undergo removal of hydrogen atoms and subsequent substitution of groups as recited above for the hydrogen atoms. Examples of such substituents include a —CONHSO₂— group (a sulfonylcarbamoyl or carbonylsulfamoyl group), a —CONHCO— group (a carbonylcarbamoyl group) and a —SO₂NHSO₂— group (a sulfonylsulfamoyl group). More specifically, these groups include alkylcarbonylaminosulfonyl groups (e.g., acetylaminosulfonyl), arylcarbonylaminosulfonyl groups (e.g., a benzoylaminosulfonyl group), alkylsulfonylaminocarbonyl groups (e.g., methylsulfonylaminocarbonyl) and arylsulfonylaminocarbonyl groups (e.g., p-methylphenylsulfonylaminocarbonyl).

Viologen dyes are compounds as epitomized by the structures shown, e.g., in the following formulae (1), (2) or (3):

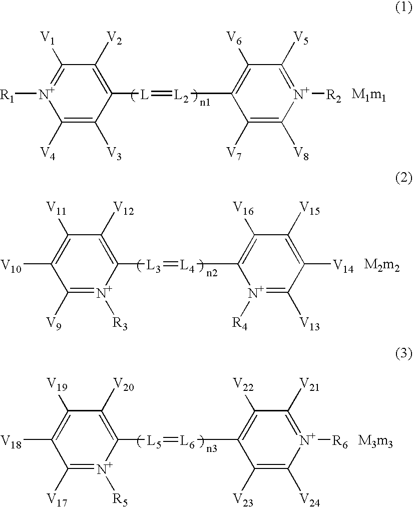

In the formulae (1), (2) and (3), V₁, V₂, V₃, V₄, V₅, V₆, V₇, V₈, V₉, V₁₀, V₁₁, V₁₂, V₁₃, V₁₄, V₁₅, V₁₆, V₁₇, V₁₈, V₁₉, V₂₀, V₂₁, V₂₂, V₂₃ and V₂₄ each represent a hydrogen atom or a univalent substituent.

R₁, R₂, R₃, R₄, R₅ and R₆ each represent a hydrogen atom, an alkyl group, an aryl group or a heterocyclic group.

L₁, L₂, L₃, L₄, L₅ and L₆ each represent a methine group or a nitrogen atom.

n₁, n₂ and n₃ each represent 0, 1 or 2.

M₁, M₂ and M₃ each represent a counter ion for charge balance, and m₁, m₂ and m₃ each represent the number of counter ions required for neutralizing charges in each molecule, which is 0 or above.

V₁, V₂, V₃, V₄, V₅, V₆, V₇, V₈, V₉, V₁₀, V₁₁, V₁₂, V₁₃, V₁₄, V₁₅, V₁₆, V₁₇, V₁₈, V₁₉, V₂₀, V₂₁, V₂₂, V₂₃ and V₂₄ represent hydrogen atoms or univalent substituents, and Vs may combine with each other, or may jointly form a ring. In addition, each V may combine with any neighbor of R₁ to R₆ or any neighbor of L₁ to L₆.

Examples of such a univalent substituent include the substituents recited as Ws hereinbefore.

R₁, R₂, R₃, R₄, R₅ and R₆ are each a hydrogen atom, an alkyl group, an aryl group or a heterocyclic group, preferably an alkyl group, an aryl group or a heterocyclic group, far preferably an alkyl group or an aryl group, particularly preferably an alkyl group. Suitable examples of an alkyl group, an aryl group and a heterocyclic group represented by each of R₁ to R₆ include 1-18C, preferably 1-7C, particularly preferably 1-4C, unsubstituted alkyl groups (e.g., methyl, ethyl, propyl, isopropyl, butyl, isobutyl, hexyl, octyl, dodecyl, octadecyl), 1-18C, preferably 1-7C, particularly preferably 1-4C, substituted alkyl groups {Examples thereof include alkyl groups substituted with Ws as recited above. Among them, alkyl groups having acidic groups in particular are preferred. The acidic groups are explained now. The term “acidic group” refers to the group having a dissociable proton. Examples of such an acidic group include a sulfo group, a carboxyl group, a sulfato group, a —CONHCO— group (a sulfonylcarbamoyl or carbonylsulfamoyl group), a —CONHCO— group (a carbonylcarbamoyl group), a —SO₂NHSO₂— group (a sulfonylsulfamoyl group), a sulfonamido group, a sulfamoyl group, a phosphato group (—OP(═O)(OH)₂), a phosphono group (—P(═O)(OH)₂), a boronic acid group and a phenolic hydroxyl group, which are groups dissociating their protons depending on their pKa values and surrounding pH values. For instance, the proton-dissociating acidic groups that can dissociate protons with a probability of 90% or more in the pH range 5-11 are appropriate. Of such groups, the preferred ones are a sulfo group, a carboxyl group, a —CONHSO₂— group, a —CONHCO— group, —SO₂NHSO₂— group, a phosphato group and a phosphono group, the far preferred ones are a carboxyl group, a phosphato group and a phosphono group, the further preferred ones are a phosphato group and a-phosphono group, and the best one is a phosphono group. Suitable examples of substituted alkyl groups include aralkyl groups (e.g., benzyl, 2-phenylethyl, 2-(4-biphenyl)ethyl, 2-sulfobenzyl, 4-sulfobenzyl, 4-sulfophenethyl, 4-phosphobenzyl, 4-carboxybenzyl), unsaturated hydrocarbon groups (e.g., an allyl group and a vinyl group, or equivalently, it is opted herein to include alkenyl and alkynyl groups in substituted alkyl groups), hydroxyalkyl groups (e.g., 2-hydroxyethyl, 3-hydroxypropyl), carboxyalkyl groups (e.g., carboxymethyl, 2-carboxyethyl, 3-carboxypropyl, 4-carboxybutyl), phosphatoalkyl groups (e.g., phosphatomethyl, 2-phosphatoethyl, 3-phosphatopropyl, 4-phosphatobutyl), phosphonoalkyl groups (e.g., phosphonomethyl, 2-phosphonoethyl, 3-phosphonopropyl, 4-phosphonobutyl), alkoxyalkyl groups (e.g., 2-methoxyethyl, 2-(2-methoxyethoxy)ethyl), aryloxyalkyl groups (e.g., 2-phenoxyethyl, 2- (4-biphenyloxy) ethyl, 2-(1-naphthoxy) ethyl, 2-(4-sulfophenoxy)ethyl, 2-(2-phosphophenoxy)ethyl), alkoxycarbonylalkyl groups (e.g., ethoxycarbonylmethyl, 2-benzyloxycarbonylethyl), aryloxycarbonylalkyl groups (e.g., 3-phenoxycarbonylpropyl, 3-sulfophenoxycarbonylpropyl), acyloxyalkyl groups (e.g., 2-acetyloxyethyl), acylalkyl groups (e.g., 2-acetylethyl), carbamoylalkyl groups (e.g., 2-morpholinocarbonylethyl), sulfamoylalkyl groups (e.g., N,N-dimethylsulfamoylmethyl), sulfoalkyl groups (e.g., 2-sulfoethyl, 3-sulfopropyl, 3-sulfobutyl, 4-sulfobutyl, 2-[3-sulfopropoxy]ethyl, 2-hydroxy-3-sulfopropyl, 3-sulfopropoxyethoxyethyl, 3-phenyl-3-sulfopropyl, 4-phenyl-4-sulfobutyl, 3-(2-pyridyl)-3-sulfopropyl), sulfoalkenyl groups, sulfatoalkyl groups (e.g., a 2-sulfatoethyl group, 3-sulfatopropyl, 4-sulfatobutyl), heterocycle-substituted alkyl groups (e.g., 2-(pyrrolidine-2-one-1-yl)ethyl, 2-(2-pyridyl)ethyl, tetrahydrofurfuryl, 3-pyridiniopropyl), alkylsulfonylcarbamoylalkyl groups (e.g., a methanesulfonylcarbamoylmethyl group), acylcarbamoylalkyl groups (e.g., anacetylcarbamoylmethyl group), acylsulfamoylalkyl groups (e.g., an acetylsulfamoylmethyl group), alkylsulfonylsulfamoylalkyl groups (e.g., a methanesulfonylsulfamoylmethyl group), ammonioalkyl groups (e.g., 3-(trimethylammonio)propyl, 3-ammoniopropyl), aminoalkyl groups (e.g., 3-aminopropyl, 3-(dimethylamino)propyl, 4-(methylamino)butyl) and guanidinoalkyl groups (e.g., 4-guanidinobutyl)}, 6-20C, preferably 6-10C, particularly preferably 6-8C, substituted or unsubstituted aryl groups (Examples of these substituted aryl groups include aryl groups substituted with the Ws recited above as examples of substituents. Among these groups, the preferred ones are aryl groups having acidic groups in particular, the far preferred ones are aryl groups substituted with carboxyl, phosphato and phosphono groups, the further preferred ones are aryl groups substituted with phosphato and phosphono groups, and the best ones are aryl groups substituted with phosphono groups. Specific examples of substituted or unsubstituted aryl groups include phenyl, 1-naphthyl, p-methoxyphenyl, p-methylphenyl, p-chlorophenyl, biphenyl, 4-sulfophenyl, 4-sulfonaphthyl, 4-carboxyphenyl, 4-phosphatophenyl and 4-phosphonophenyl.), and 1-20C, preferably 3-10C, particularlypreferably 4-8C, substituted or unsubstituted heterocyclic groups (Examples of these substituted heterocyclic groups include heterocyclic groups substituted with the Ws recited above as examples of substituents. Among these groups, the preferred ones are heterocyclic groups having acidic groups in particular, the far preferred ones are heterocyclic groups substituted with carboxyl, phosphato and phosphono groups, the further preferred ones are heterocyclic groups substituted with phosphato and phosphono groups, and the best ones are heterocyclic groups substituted with phosphono groups. Specific examples of such substituted and unsubstituted heterocyclic groups include 2-furyl, 2-thienyl, 2-pyridyl, 3-pyrazolyl, 3-isooxazolyl, 3-isothiazolyl, 2-imidazolyl, 2-oxazolyl, 2-thiazolyl, 2-pyridazinyl, 2-pyrimidyl, 3-pyrazinyl, 2-(1,3,5-triazolyl), 3-(1,2,4-triazolyl), 5-tetrazolyl, 5-methyl-2-thienyl, 4-methoxy-2-pyridyl, 4-sulfo-2-pyridyl, 4-carboxy-2-pyridyl, 4-phosphato-2-pyridyl and 4-phosphono-2-pyridyl).

Alternatively, each of R₁ to R₆ may combine with any of other Rs, V₁ to V₂₄ and L₁ to L₆.

Each of L₁, L₂, L₃, L₄, L₅ and L₆ represents a methine group or a nitrogen atom, preferably a methine group. The methine group represented by each of L₁ to L₆ may have a substituent, and examples of such a substituent include the Ws recited above. More specifically, those substituents include 1-15C, preferably 1-10C, particularly preferably 1-5C, substituted or unsubstituted alkyl groups (e.g., methyl, ethyl, 2-carboxyethyl, 2-phosphatoethyl, 2-phosphonoethyl), 6-20C, preferably 6-15C, far preferably 6-10C, substituted or unsubstituted aryl groups (e.g., phenyl, o-carboxyphenyl, o-phosphatophenyl, o-phosphonophenyl), 3-20C, preferably 4-15C, far preferably 6-10C, substituted or unsubstituted heterocyclic groups (e.g., N,N-dimethylbarbituric acid group), halogen atoms (e.g., chlorine, bromine, iodine, fluorine), 1-15C, preferably 1-10C, far preferably 1-5C, alkoxy groups (e.g., methoxy, ethoxy), 0-15C, preferably 2-10C, far preferably 4-10C, amino groups (e.g., methylamino, N,N-dimethylamino, N-methyl-N-phenylamino, N-methylpiperazino), 1-15C, preferably 1-10C, far preferably 1-5C, alkylthio groups (e.g., methylthio, ethylthio), and 6-20C, preferably 6-12C, far preferably 6-10C, arylthio groups (e.g., phenylthio, p-methylphenylthio). The methine group as each of L₁, L₂, L₃, L₄, L₅ and L₆ may combine with any of the other methine groups to form a ring, or may combine with any of V₁ to V₂₄ and R₁ to R₆.

n₁, n₂ and n₃ each represent 0, 1 or 2, preferably 0 or 1, far preferably 0. When n₁ to n₃ are 2 or above, a methine group or a nitrogen atom is repeated, but it is not required for the repeated ones to be the same.

M₁, M₂ and M₃ are included in the formulae, respectively, for indicating the presence of cations or anions when they are required for neutralizing ionic charges in compounds. Examples of a typical cation include hydrogen ion (H⁺), inorganic cations, such as alkali metal ions (e.g., sodium ion, potassium ion, lithium ion) and alkaline earth metal ions (e.g., calcium ion), and organic cations, such as ammonium ions (e.g., ammonium ion, tetraalkylammonium ions, triethylammonium ion, pyridinium ion, ethylpyridinium ion, 1,8-diazabicyclo[5.4.0]-7-undecenium ion) Anions may be any of inorganic and organic anions, and examples thereof include halide anions (e.g., fluoride ion, chloride ion, iodide ion), substituted arylsulfonate ions (e.g., p-toluenesulfonate ion, p-chlorobenzenesulfonate ion), aryldisulfonate ions (e.g., 1,3-benzenesulfonate ion, 1,5-naphthalenedisulfonate ion, 2,6-naphthalenedisulfonate ion), alkylsulfate ions (e.g., methylsulfate ion), sulfate ion, thiocyanate ion, perchlorate ion, tetrafluoroborate ion, picrate ion, acetate ion and trifluoromethanesulfonate ion. Further, other dyes having charges opposite in polarity to the ionic polymers or the dyes maybe used. In addition, when CO₂⁻, SO₃⁻ and p(═O)(—O⁻)₂ have hydrogen ions as counter ions, it is possible to denote them as CO₂H, SO₃H and P(═O)(—OH)₂, respectively.

Each of m₁, m₂ and m₃ represents the number of counter ions for attaining charge balance, and it is specifically a number of 0 or above, preferably 0 to 4, far preferably 0 to 2. When each of the compounds forms an inner salt, the number represented by m₁, m₂ and m₃ each is zero.

Examples of compounds as viologen dyes are illustrated below, but viologen dyes usable in the invention are not construed as being limited to these examples.

[Ka2]

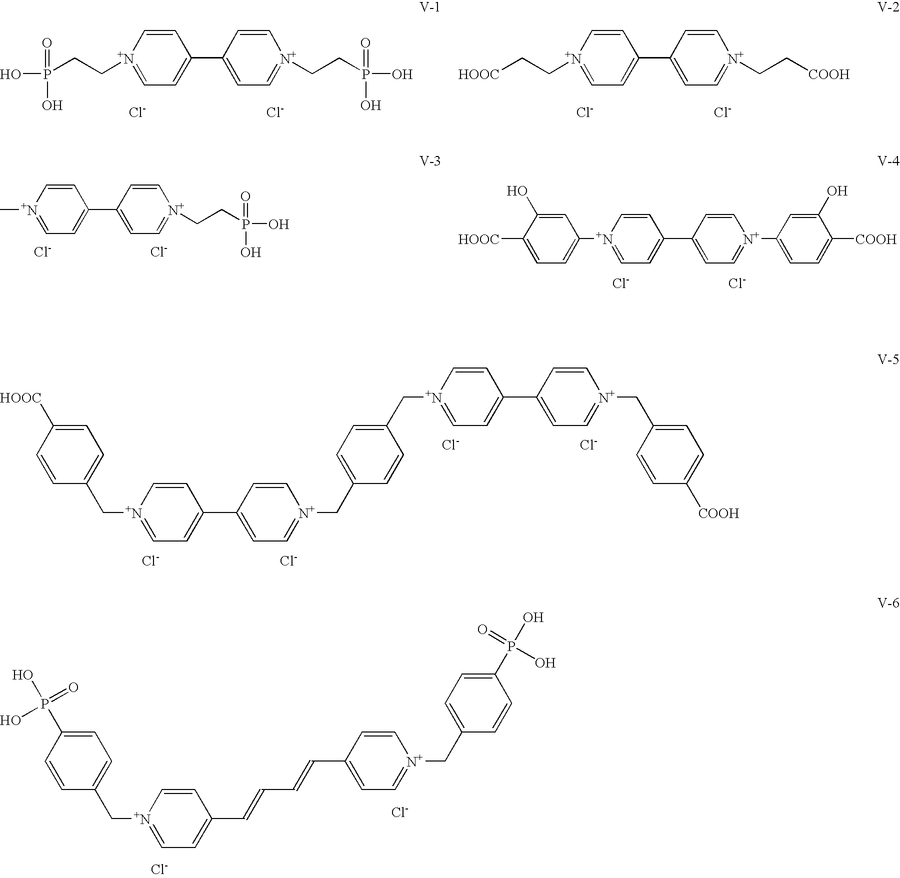

[Ka3]

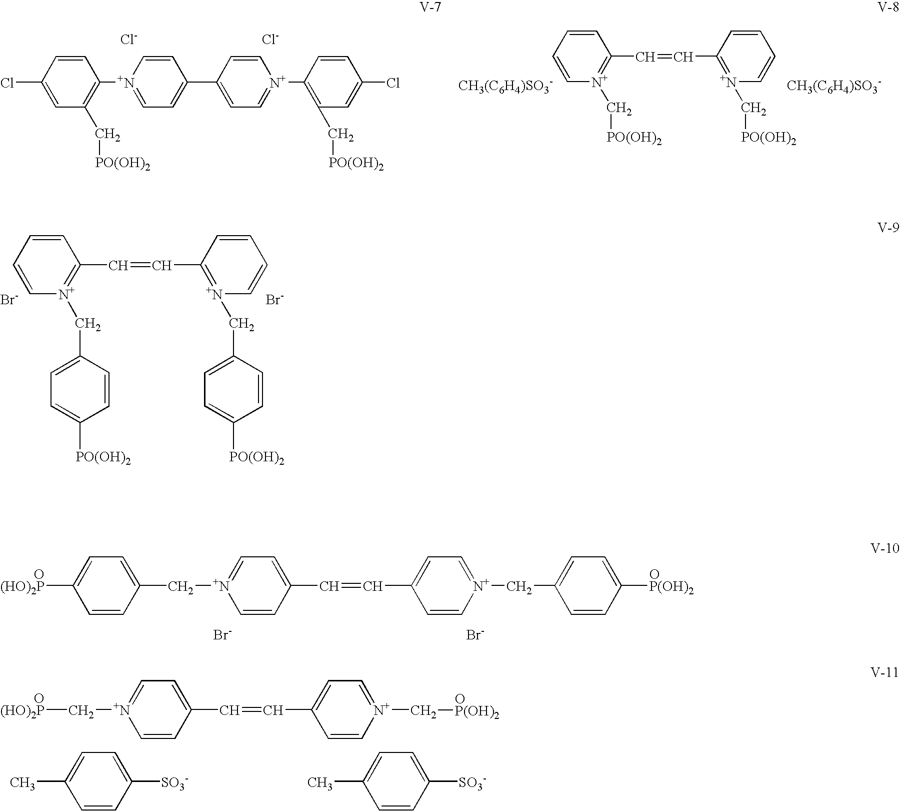

The phenothiazine dyes are compounds epitomized by the structure shown in the following formula (6):

[Ka4]

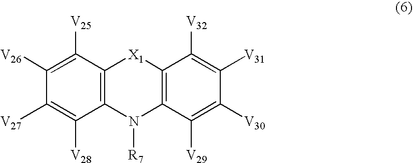

In formula (6), V₂₅, V₂₆, V₂₇, V₂₈, V₂₉, V₃₀, V₃₁ and V₃₂ each represent a hydrogen atom or a univalent substituent, and Vs may combine with each other, or may jointly form a ring. In addition, each V may be combined with R₇.

Examples of such a univalent substituent include the substituents recited as Ws hereinbefore.

R₇ represents a hydrogen atom, an alkyl group, an aryl group or a heterocyclic group, preferably an alkyl group, an aryl group or a heterocyclic group, far preferably an alkyl group or an aryl group, particularly preferably an alkyl group. Suitable examples of an alkyl group, an aryl group and aheterocyclic group represented by R₇ include 1-18C, preferably 1-7C, particularly preferably 1-4C, unsubstituted alkyl groups (e.g., methyl, ethyl, propyl, isopropyl, butyl, isobutyl, hexyl, octyl, dodecyl, octadecyl), 1-18C, preferably 1-7C, particularly preferably 1-4C, substituted alkyl groups {Examples thereof include alkyl groups substituted with Ws as recited above. Among them, alkyl groups having acidic groups in particular are preferred. Herein, the acidic groups are explained. The term “acidic group” refers to the group having a dissociable proton. Examples of such an acidic group include a sulfo group, a carboxyl group, a sulfato group, a —CONHCO— group (a sulfonylcarbamoyl or carbonylsulfamoyl group), a —CONHCO— group (a carbonylcarbamoyl group), a —SO₂NHSO₂— group (a sulfonylsulfamoyl group), a sulfonamido group, a sulfamoyl group, aphosphato group (—OP(═O)(OH)₂), aphosphonogroup (—P═O)(OH)₂), a boronic acid group and a phenolic hydroxyl group, which are groups dissociating their protons depending on their pKa values and surrounding pH values. For instance, the proton-dissociating acidic groups that can dissociate protons with a probability of 90% or more in the pH range 5-11 are appropriate. Of such groups, the preferred ones are a sulfo group, a carboxyl group, a —CONHSO₂— group, a —CONHCO— group, —SO₂NHSO₂— group, a phosphate group and a phosphono group, the far preferred ones are a carboxyl group, a phosphato group and a phosphono group, the further preferred ones are a phosphato group and a phosphono group, and the best one is a phosphono group. Suitable examples of substituted alkyl groups include aralkyl groups (e.g., benzyl, 2-phenylethyl, 2-(4-biphenyl)ethyl, 2-sulfobenzyl, 4-sulfobenzyl, 4-sulfophenethyl, 4-phosphobenzyl, 4-carboxybenzyl), unsaturated hydrocarbon groups (e.g., an allyl group and a vinyl group, or equivalently, it is opted herein to include alkenyl and alkynyl groups in substituted alkyl groups), hydroxyalkyl groups (e.g., 2-hydroxyethyl, 3-hydroxypropyl), carboxyalkyl groups (e.g., carboxymethyl, 2-carboxyethyl, 3-carboxypropyl, 4-carboxybutyl), phosphatoalkyl groups (e.g., phosphatomethyl, 2-phosphatoethyl, 3-phosphatopropyl, 4-phosphatobutyl), phosphonoalkyl groups (e.g., phosphonomethyl, 2-phosphonoethyl, 3-phosphonopropyl, 4-phosphonobutyl), alkoxyalkyl groups (e.g., 2-methoxyethyl, 2-(2-methoxyethoxy)ethyl), aryloxyalkyl groups (e.g., 2-phenoxyethyl, 2-(4-biphenyloxy)ethyl, 2-(1-naphthoxy)ethyl, 2-(4-sulfophenoxy)ethyl, 2-(2-phosphophenoxy)ethyl), alkoxycarbonylalkyl groups (e.g., ethoxycarbonylmethyl, 2-benzyloxycarbonylethyl), aryloxycarbonylalkyl groups (e.g., 3-phenoxycarbonylpropyl, 3-sulfophenoxycarbonylpropyl), acyloxyalkyl groups (e.g., 2-acetyloxyethyl), acylalkyl groups (e.g., 2-acetylethyl), carbamoylalkyl groups (e.g., 2-morpholinocarbonylethyl), sulfamoylalkyl groups (e.g., N,N-dimethylsulfamoylmethyl), sulfoalkyl groups (e.g., 2-sulfoethyl, 3-sulfopropyl, 3-sulfobutyl, 4-sulfobutyl, 2-[3-sulfopropoxy]ethyl, 2-hydroxy-3-sulfopropyl, 3-sulfopropoxyethoxyethyl, 3-phenyl-3-sulfopropyl, 4-phenyl-4-sulfobutyl, 3-(2-pyridyl)-3-sulfopropyl), sulfoalkenyl groups, sulfatoalkyl groups (e.g., a 2-sulfatoethyl group, 3-sulfatopropyl, 4-sulfatobutyl), heterocycle-substituted alkyl groups (e.g., 2-(pyrrolidine-2-one-1-yl)ethyl, 2-(2-pyridyl)ethyl, tetrahydrofurfuryl, 3-pyridiniopropyl), alkylsulfonylcarbamoylalkyl groups (e.g., a methanesulfonylcarbamoylmethyl group), acylcarbamoylalkyl groups (e.g., an acetylcarbamoylmethyl group), acylsulfamoylalkyl groups (e.g., an acetylsulfamoylmethyl group), alkylsulfonylsulfamoylalkyl groups (e.g., a methanesulfonylsulfamoylmethyl group), ammonioalkyl groups (e.g., 3-(trimethylammonio) propyl, 3-ammoniopropyl), aminoalkyl groups (e.g., 3-aminopropyl, 3-(dimethylamino)propyl, 4-(methylamino)butyl) and guanidinoalkyl groups (e.g., 4-guanidinobutyl)}, 6-20C, preferably 6-10C, particularly preferably 6-8C, substituted or unsubstituted aryl groups (Examples of these substituted aryl groups include aryl groups substituted with the Ws recited above as examples of substituents. Among these groups, the preferred ones are aryl groups having acidic groups in particular, the far preferred ones are aryl groups substituted with carboxyl, phosphato and phosphono groups, the further preferred ones are aryl groups substituted with phosphato and phosphono groups, and the best ones are aryl groups substituted with phosphono groups. Specific examples of substituted or unsubstituted aryl groups include phenyl, 1-naphthyl, p-methoxyphenyl, p-methylphenyl, p-chlorophenyl, biphenyl, 4-sulfophenyl, 4-sulfonaphthyl, 4-carboxyphenyl, 4-phosphatophenyl and 4-phosphonophenyl.), and 1-20C, preferably 3-10C, particularly preferably 4-8C, substituted or unsubstituted heterocyclic groups (Examples of these substituted heterocyclic groups include heterocyclic groups substituted with the Ws recited above as examples of substituents. Among these groups, the preferred ones are heterocyclic groups having acidic groups in particular, the far preferred ones are heterocyclic groups substituted with carboxyl, phosphato and phosphono groups, the further preferred ones are heterocyclic groups substituted with phosphato and phosphono groups, and the best ones are heterocyclic groups substituted with phosphono groups. Specific examples of such substituted and unsubstituted heterocyclic groups include 2-furyl, 2-thienyl, 2-pyridyl, 3-pyrazolyl, 3-isooxazolyl, 3-isothiazolyl, 2-imidazolyl, 2-oxazolyl, 2-thiazolyl, 2-pyridazinyl, 2-pyrimidyl, 3-pyrazinyl, 2-(1,3,5-triazolyl), 3-(1,2,4-triazolyl), 5-tetrazolyl, 5-methyl-2-thienyl, 4-methoxy-2-pyridyl, 4-sulfo-2-pyridyl, 4-carboxy-2-pyridyl, 4-phosphato-2-pyridyl and 4-phosphono-2-pyridyl).

Alternatively, R₇ may be combined with any of V₂₅ to V₃₂.

X₁ represents a sulfur atom, an oxygen atom, a nitrogen atom (N—Rₐ), a carbon atom (CVₐV_{b}) or a selenium atom, preferably a sulfur atom. Additionally, Rₐ represents a hydrogen atom, an alkyl group, an aryl group or a heterocyclic group. Examples thereof include the same groups as examples of the foregoing R₁ to R₇ each include, and the same ones are preferred. Vₐ and V_{b} represent hydrogen atoms or univalent substituents. Examples thereof include the same groups as examples of the foregoing V₁ to V₃₂ each include, and the same ones are preferred.

M₄ is included in the formula for indicating the presence of a cation or an anion when it is required for neutralizing ionic charges in a compound. Examples of a typical cation include hydrogen ion (H⁺), inorganic cations, such as alkali metal ions (e.g., sodium ion, potassium ion, lithium ion) and alkaline earth metal ions (e.g., calcium ion), and organic cations, such as ammonium ions (e.g., ammonium ion, tetraalkylammonium ions, triethylammonium ion, pyridinium ion, ethylpyridinium ion, 1,8-diazabicyclo[5.4.0]-7-undecenium ion). Anions may be any of inorganic and organic anions, and examples thereof include halide anions (e.g., fluoride ion, chloride ion, iodide ion), substituted arylsulfonate ions (e.g., p-toluenesulfonate ion, p-chlorobenzenesulfonate ion), aryldisulfonate ions (e.g., 1,3-benzenesulfonate ion, 1,5-naphthalenedisulfonate ion, 2,6-naphthalenedisulfonate ion), alkylsulfate ions (e.g., methylsulfate ion), sulfate ion, thiocyanate ion, perchlorate ion, tetrafluoroborate ion, picrate ion, acetate ion and trifluoromethanesulfonate ion. Further, other dyes having charges opposite in polarity to the ionic polymers or the dyes may be used. In addition, when CO₂⁻, SO₃⁻ and p(═O)(—O—)₂ have hydrogen ions as counter ions, it is possible to denote them as CO₂H, SO₃H and P(═O)(—OH)₂, respectively.

m₄ represents the number of counter ions for attaining charge balance, and it is specifically a number of 0 or above, preferably 0 to 4, far preferably 0 to 2. When the compound forms an inner salt, the number represented by m₄ is zero.

Examples of compounds as phenothiazine dyes are illustrated below, but phenothiazine dyes usable in the invention are not construed as being limited to these examples.

[Ka5]

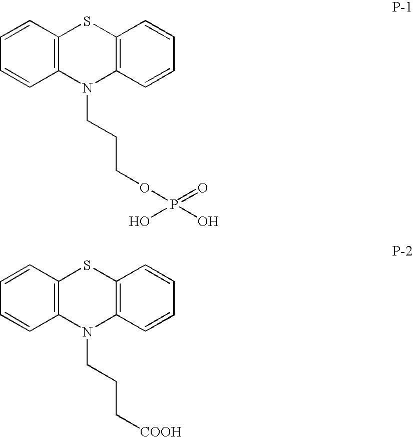

Styryl dyes are compounds having the fundamental structure represented by the following formula (7).

[Ka6]

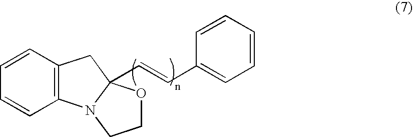

In the above formula, n is from 1 to 5. This compound may have an arbitrary substituent at any site in the formula, but it is particularly advantageous for the compound to have an adsorptive substituent, such as a carboxyl group, a sulfonic acid group or a phosphonic acid group. The compounds illustrated below can be given as examples, but styryl dyes usable in the invention should not be construed as being limited to these examples.

[Ka7]

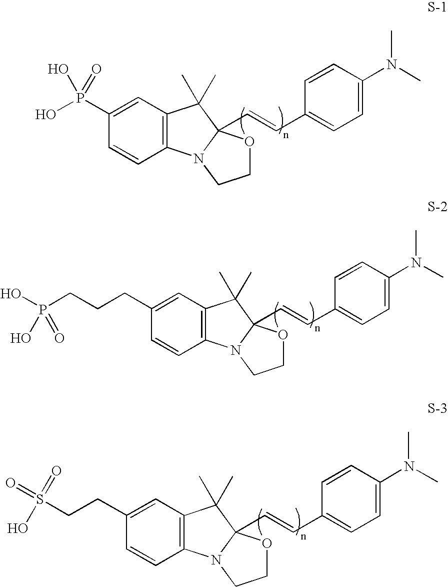

As for organic compounds of those electrochromic materials, their absorption wavelengths can be controlled by substituent changes. In addition, it is preferable to use two or more kinds of electrochromic materials capable of altering their optical densities, thereby allowing the optical density-altering element to alter its optical densities at different wavelengths.

When an optical device according to the invention is used as a light control device of a camera unit or the like, it is preferable that the optical device has an absorption characteristic close to neutral gray that uniformly absorbs optical radiation, and the density altering element absorbs visible radiation, preferably visible light with a plurality of different wavelengths, far preferably blue light, green light and red light. Further, such a absorption characteristic can be achieved by a combination of a plurality of materials exhibiting absorption in the visible region. Suitable examples of a combination of two or more different materials include a combination of a viologen dye and a phenothiazine dye, a combination of a viologen dye and a ferrocene dye, a combination of a phthalocyanine dye and prussian blue, a combination of a viologen dye and nickel oxide, a combination of a viologen dye and iridium oxide, a combination of tungsten oxide and a phenothiazine dye, a combination of a viologen dye, a phenothiazine dye and a styryl dye, a combination of two varieties of viologen dyes (differing in substituents) and a phenothiazine dye, a combination of two varieties of viologen dyes (differing in substituents) and a styryl dye, and a combination of two varieties of viologen dyes (differing in substituents) and nickel oxide.

For the purpose of promoting electrochemical reaction of those electrochromic materials, oxidizable/reducible auxiliary compounds may be further present in the optical density-altering element. The auxiliary compounds maybe compounds of the type which cause no change or compounds of the type which cause some change in optical densities at λ=400 nm to 700 nm when undergo oxidation or reduction. The auxiliary compounds may be present on metal oxides as is the case with the electrochromic materials, or may be dissolved in an electrolyte, or may form a layer by itself on an electrical conduction layer.

The electrolyte as a constituent of the optical density-altering element includes a solvent and a supporting electrolyte. The supporting electrolyte itself never causes electrochemical reaction by transfer of electric charges and takes charge of enhancing the conductivity. The solvent is preferably a polar solvent, with examples including water, alcohol such as methanol or ethanol, carboxylic acid such as acetic acid, acetonitrile, propionitrile, glutaronitrile, adiponitrile, methoxyacetonitrile, dimethylacetamide, methylpyrrolidinone, formamide, N,N-dimethylformamide, dimethyl sulfoxide, dimethoxyethane, propylene carbonate, ethylene carbonate, γ-butyrolactone, tetrahydrofuran, dioxolan, sulfolane, trimethylphosphate, pyridine, hexamethylenic acid triamide, and polyethylene glycol.

The supporting electrolyte is present as ions in a solvent and acts as a charge carrier, and it is a salt formed by combining easily ionizable anion and cation. Examples of such a cation include metal ions, typified by Li⁺, Na⁺, K⁺, Rb⁺ and Cs⁺, and quaternary ammonium ions, typified by tetrabutylammonium ion. Examples of such an anion include halide ions, typified by Cl⁻, Br⁻, I⁻ and F⁻, sulfate ion, nitrate ion, perchlorate ion, tosylate ion, tetrafluoroborate ion, and hexafluorophosphate ion. Examples of other electrolytes include fused-salt electrolytes, typified by LiCl/KCl, solid electrolytes, typified by ionic conductors and superionic conductors, and solid polymeric electrolytes, typified by membranous ionic conductive material like ion exchange film.

It is preferable that the optical density of an optical device according to the invention at the wavelength of 400 nm is controlled to 0.2 or below, especially 0.125 or below, in a discolored state by appropriately combining materials for an optical density-altering element, namely optimizing the kinds of a support, an electrical conduction layer and a electrochromic material, and besides, by optimizing the kind and the grain size of a semiconductive material. In a similar manner thereto, it is preferable that the average value of optical densities at λ=400 nm to 500 nm in the discolored state, the average value of optical densities at λ=500 nm to 600 nm in the discolored state and the average value of optical densities at λ=600 nm to 700 nm in the discolored state are all controlled to 0.1 or below. On the other hand, when the optical device responds to irradiation with electromagnetic waves, the average value of its optical densities at λ=400 nm to 700 nm is preferably 0.5 or above, far preferably 0.8 or above, particularly preferably 0.95 or above.

In an optical device according to the invention, connection between an optical density-altering element and an electromotive-force generation element may be established directly or via circuits having functions of amplifying, protecting and so on. In addition, the optical device may have a circuitry design to promote dissolution of applied voltage at the time of interception of light by having a resistor connected in parallel to the optical density-altering element.

An optical device according to the invention is adaptable to any of a window material for vehicles, a display, a camera-related optical device and the like. One application example in which an optical device according to the invention can fully achieve its effectiveness is a camera-related optical device. More specifically, the present optical device is effective on all of camera units including large and medium format cameras, a single-lens reflex camera, a compact camera, a film with lens, a digital camera, a broadcast camera, a motion-picture film camera, a motion-picture digital camera, a mobile phone-specific camera unit and an 8 mm movie camera. As cases where the present optical device can make the most of its features, there are simple picture-taking systems involving no complex control mechanism, typified by films with lens. As other cases where the present optical device can demonstrate its features, there are digital cameras equipped with CCDs or CMOSes as image pickup devices, and narrowness of the dynamic range of such an image pickup device can be supplemented by the present optical device.

When an optical device according to the invention is applied to a camera unit, the optical density-altering element thereof is preferably placed on the optical axis of a lens. In addition, it is more advantageous for the electromotive-force generation element, the optical density-altering element and the photosensitive elements of the camera (including a photosensitive material (like a film) and CCD) to have the greater amount of overlap among their light absorption characteristics (light absorption wavelengths and spectral sensitivities). When the amount of overlap is greater particularly between the absorption wavelength range of the optical density-altering element and the spectral sensitivity region of the photosensitive elements of the camera, the more satisfactory results are obtained. Thus, neutral gray adjustment can be achieved over the full range of spectral sensitivities of a camera.

### EXAMPLES

In order to illustrate the invention in more detail, the following examples are given, but the invention should not be construed as being limited to these examples.

### Examples 1 to 2, and Comparativve Example

Example 1 in which an optical device according to the invention is mounted on the subject side of a lens of a film with lens, and Example 2 in which an optical device according to the invention is mounted on the imaging recording medium side of a lens of a film with lens are presented.

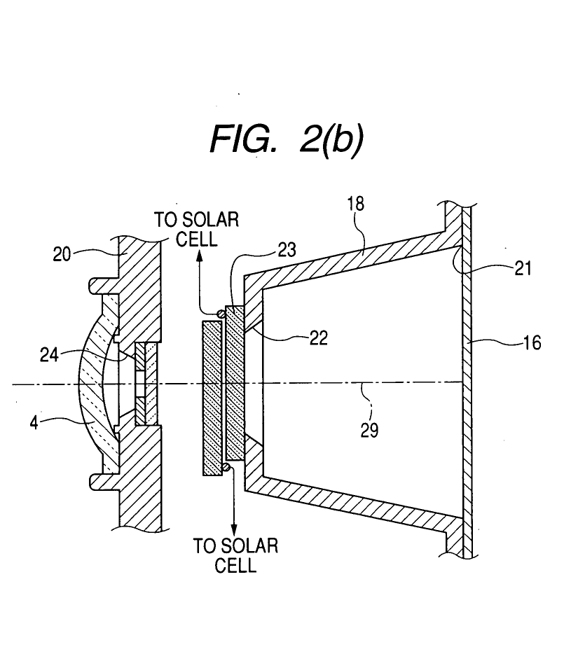

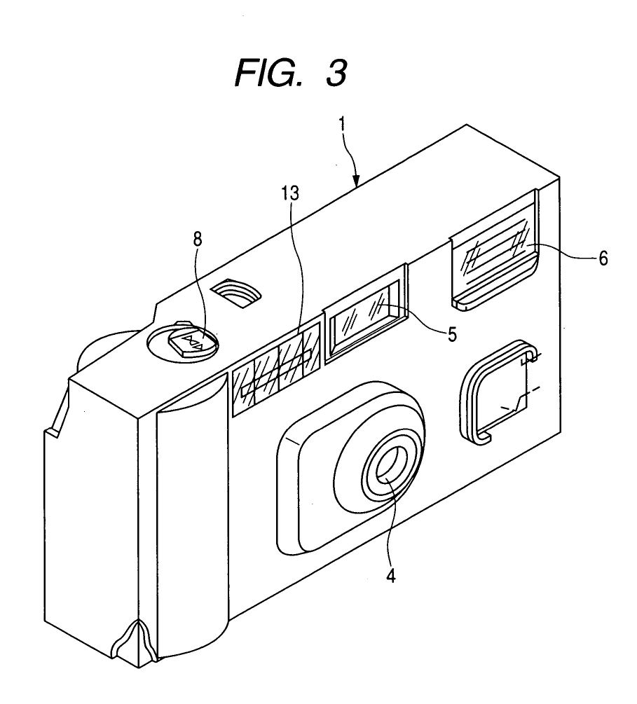

A film with lens in a mode for carrying out the invention, as shown in FIG. 2 or FIG. 3, is equipped with (1) a light control filter 23 (an optical density-altering element) and (2) a solar cell 13 (an electromotive-force generation element). By placing the solar cell 13 on the outside of the unit, an electromotive force is generated in accordance with the intensity of external light, and the amount of light reaching to a photographic film 16 is controlled by a light control filter 23 responsive to the electromotive force generated; as a result, over-exposed negative in a high-luminance environment can be prevented. Details and preparation methods of (1) a light control filter and (2) a solar cell are described below.

(1) Light Control Filter

A light control filter was made following the steps of (i) applying a nanoparticulate tin-oxide coating for a cathode, (ii) applying a nanoparticulate tin-oxide coating for an anode, (iii) adsorbing an electrochromic material, and (iv) assembling components into a filter device.

(i) Application of Nanoparticulate Tin-Oxide Coating for Cathode

Polyethylene glycol (molecular weight: 20,000) was added to a aqueous dispersion of tin oxide measuring about 40 nm in diameter, and stirred homogeneously to prepare a coating solution. As a substrate to be coated with the coating solution was used a transparent glass with a 0.7 mm-thick antireflective film covered with conductive SnO₂-evaporated film. On the SnO₂ film of the transparent conductive glass substrate, the coating solution was put uniformly so that the tin oxide had a coverage of 9 g/m². Thereafter, the glass substrate was burned at 450° C. for 30 minutes to remove the high polymer, thereby preparing a tin oxide nanoporous electrode. The thus prepared electrode had a surface roughness factor of about 750.

(ii) Application of Nanoparticulate Tin-Oxide Coating for Anode

Polyethylene glycol (molecular weight: 20,000) was added to a aqueous dispersion of tin oxide having an average diameter of 5 nm, and stirred homogeneously to prepare a coating solution. As a substrate to be coated with the coating solution was used a transparent glass with a 0.7 mm-thick antireflective film covered with conductive SnO₂-evaporated film. On the SnO₂ film of the transparent conductive glass substrate, the coating solution was put uniformly, and then the temperature of the glass substrate was raised up to 450° C. over 100 minutes and further burned at 450° C. for 30 minutes to remove the high polymer. These coating and burning operations were repeated until the total coverage of tin oxide reached 7 g/m², thereby preparing a tin oxide nanoporous electrode. The thus prepared electrode had a surface roughness factor of about 750.

(iii) Adsorption of Electrochromic Material

The following chromic Dyes (V-1) and (P-1) were used as electrochromic materials. The chromic Dye (V-1) has a property of generating a color by reduction occurring at a cathode (minus pole), and the chromic Dye (P-1) has a property of generating a color by oxidation occurring at an anode (plus pole). Herein, the colors generated by chromic Dyes (V-1) and (P-1) are different from each other. In other words, these two kinds of electrochromic materials alter optical densities at different wavelengths as their colors are generated.

Chromic Dyes (V-1) and (P-1)

[Ka8]

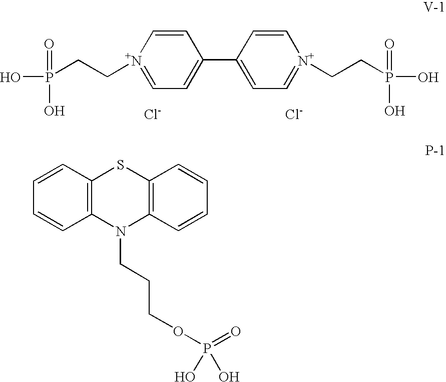

V-1 and P-1 were dissolved in a water solvent and a mixed chloroform-methanol solvent, respectively, so as to have a concentration of 0.02 mol/L, and in the V-1 solution and the P-1 solution thus prepared were immersed the tin-oxide nanoporous electrode made in (i) and the tin-oxide nanoporous electrode made in (ii), respectively. Therein, chemical adsorption was conducted at 40° C. for 3 hours. After the chemical adsorption, the glass substrates were cleaned with their respective solvents, and dried under vacuum.

Incidentally, besides the foregoing immersion method as an adsorption method of an electrochromic material to nanoparticules, it is possible to adopt a method of mixing an electrochromic material in each of the coating solutions used for applying nanoparticles to transparent conductive glass substrates in the steps (i) and (ii), respectively, and thereby adsorbing the electrochromic material to nanoparticles.

(iv) Filter Device

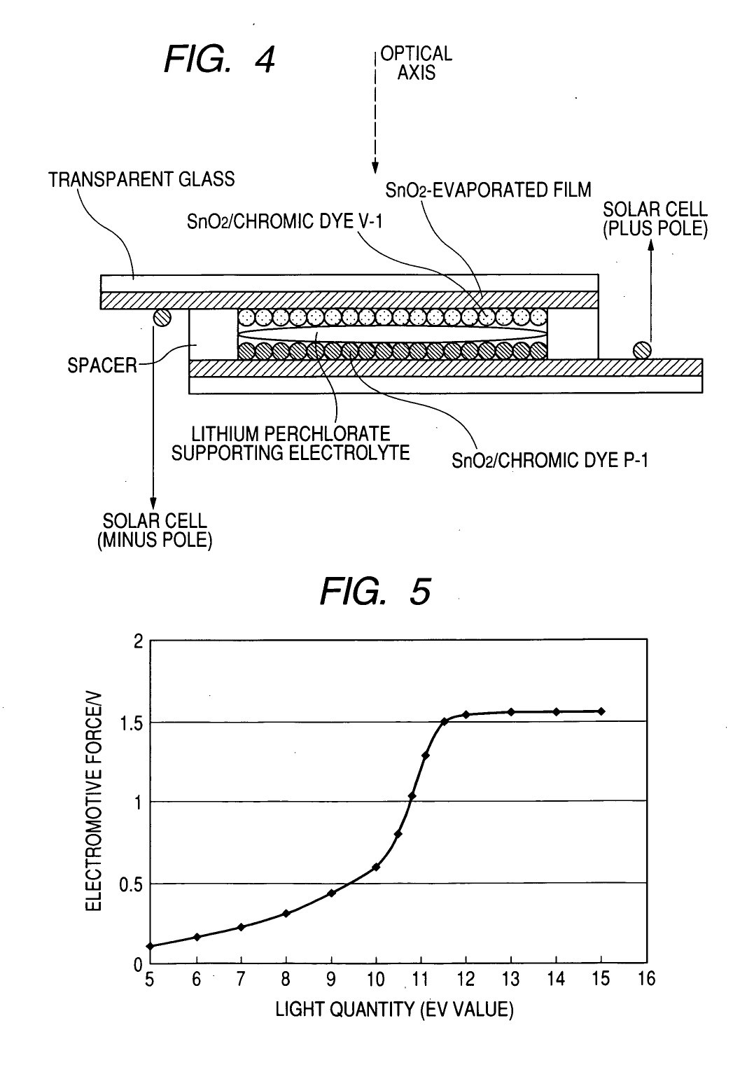

The Dye V-1 adsorbed tin oxide nanoporous electrode and the Dye P-1 adsorbed tin oxide nanoporous electrode were placed so as to face each other as shown in FIG. 4, and a γ-butyrolactone solution containing 0.2 mol/l of lithium perchlorate was sealed up as an electrolyte in a clearance formed between those electrodes, thereby forming a device as a light control filter. At the occasion of establishing connection with a solar cell, the Dye V-1 adsorbed tin oxide nanoporous electrode was connected to the minus pole of the solar cell, and the Dye P-1 adsorbed tin oxide electrode was connected to the plus pole of the solar cell.

(2) Solar Cell

As to the solar cell, a silicon-type solar cell SS-3012DS (made by Sinonar Corporation) was used. Unit cells of such a solar cell were placed in series so as to generate an electromotive force of about 1.5V. The electromotive force characteristic of the solar cell used with respect to the light quantity of imitation sun light (combined use of a xenon lamp and a spectral filter AM1.5 made by Oriel Co., Ltd.) is shown in FIG. 5.

Film with lens units having structures shown in the following Table 1 were each made using the forgoing light control filter (1) and solar cell (2). The ISO speed of a film used was 1,600, the aperture setting was F8, and the shutter speed setting was 1/85″. When the picture-taking system configured so as to meet the foregoing conditions was used, picture-taking under the condition of EV=8.4 delivered negatives of optimum densities.

TABLE 1

| Sample No. | Solar cell | Light control filter |
|---|---|---|
| 101 | not equipped | not mounted |
| (Comparative Example) | | |
| 102 | equipped | mounted |
| (Example 1) | | (on the subject side of a lens) |
| 103 | equipped | mounted |
| (Example 2) | | (on the imaging recording |
| | | medium side of a lens) |

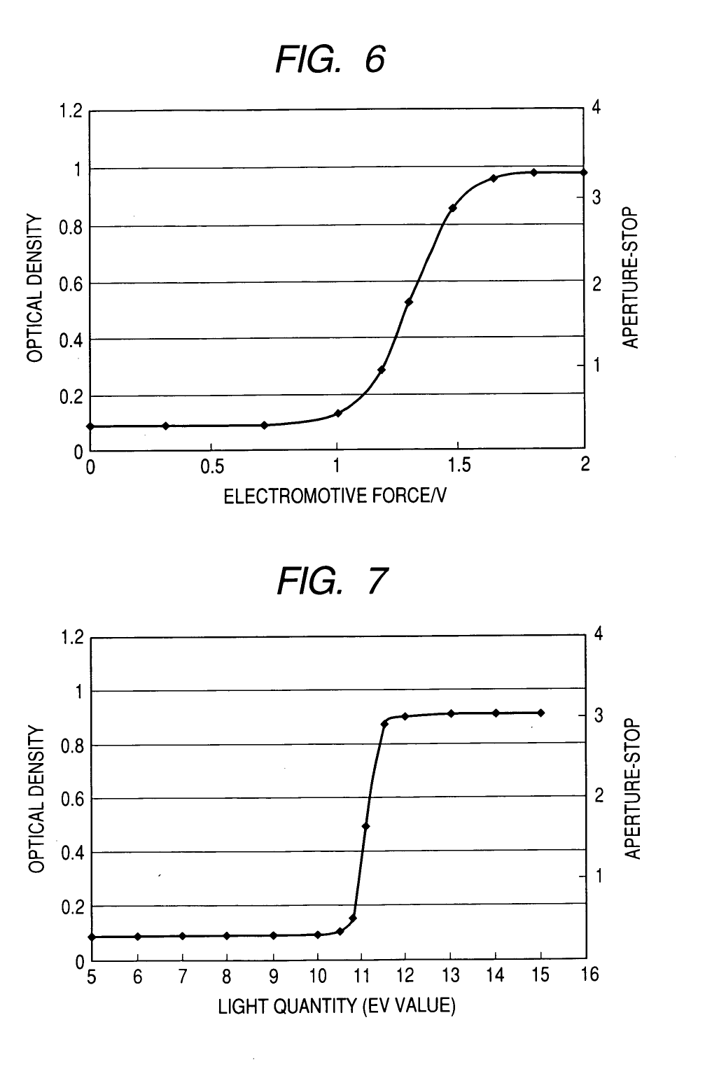

The optical density characteristics of the optical devices used in Sample 102 and Sample 103 are shown in FIG. 6. Further, the optical density response characteristics of the optical devices each having the combination of the solar cell and the light control filter with respect to the light quantities obtained from those results are shown in FIG. 7. Each optical density value shown therein is the average value of optical densities at λ=400 nm to 700 nm. In those figures, how many aperture-stops each rise in optical density corresponds to as expressed in the so-called “aperture stop” terms used commonly-in picture-taking systems is also indicated. Incidentally, a change in aperture-stop number by +1 corresponds to a 50 % reduction in quantity of transmitted light, or a 0.3 rise in optical density. As shown in FIG. 7, the aperture-stop of this optical device was +0.3 when light was intercepted, and it was raised to +2.9 by irradiation with light of EV=11.5 and up to +3.0 by irradiation with light of EV=12.0 or above. The response time to these changes was 5 seconds. The EV as used herein is a value indicating brightness, and can be calculated from the brightness L expressed in the practical unit lux of illuminance by use of the following equation (2):
EV=log₂(L/2.4) Equation (2)

Making additional remarks about the relationship of EV with the foregoing aperture-stop, a change of +1 aperture-stop of an optical device corresponds to a decrease of 1 in EV value of the brightness of light received through the optical device.

Pictures were taken with the foregoing sample units 101, 102 and 103 in various brightness situations ranging from EV=6.4 (equivalent to the brightness in a dark room) to EV=15.4 (equivalent to the brightness under a clear sky in midsummer), and Fuji Photo Film CN-16 development processing was performed for 3 minutes and 15 seconds. Comparisons among exposure levels of the thus obtained negatives are shown in Table 2. Additionally, the term “exposure level” as used herein indicates the evaluation of correctness of the density of a negative after processing, and the density of the optimum negative is taken as 0. In the cases of the picture-taking systems used herein, as mentioned above, the negatives having the optimum densities can be obtained when pictures are taken under the condition of EV=8.4. In other words, the exposure level becomes zero in such cases. The exposure level of +1 means that the density obtained is one aperture-stop darker (equivalent to 0.3 higher in the optical density terms) than the correct gray density, while the exposure level of −1 means that the density obtained is one aperture-stop lighter (equivalent to 0.3 lower in the optical density terms) than the correct gray density).

TABLE 2

| Sample | Picture-taking Condition | | | | | | | | | |
|---|---|---|---|---|---|---|---|---|---|---|
| No. | EV = 6.4 | EV = 7.4 | EV = 8.4 | EV = 9.4 | EV = 10.4 | EV = 11.4 | EV = 12.4 | EV = 13.4 | EV = 14.4 | EV = 15.4 |
| 101 | −2.0 | −1.0 | 0 | +1.0 | +2.0 | +3.0 | +4.0 | +5.0 | +6.0 | +7.0 |
| (Compar. | | | | | | | | | | |
| Example) | | | | | | | | | | |
| 102 | −2.3 | −1.3 | −0.3 | +0.7 | +1.7 | +0.4 | +1.0 | +2.0 | +3.0 | +4.0 |
| (Example 1) | | | | | | | | | | |
| 103 | −2.3 | −1.3 | −0.3 | +0.7 | +1.7 | +0.4 | +1.0 | +2.0 | +3.0 | +4.0 |
| (Example 2) | | | | | | | | | | |

When it is assumed that photo prints are made from the negatives obtained herein, certain degrees of exposure level deviation can be corrected. More specifically, correction at the time of printing is possible so long as the negatives are on the exposure levels ranging from −1 to +4, and so “photographs proving the shooting successful” can be obtained. When the exposure level is outside the foregoing range, the correction at the time of printing becomes no longer sufficient to result in production of “unsuccessful photographs”. Whether the photographs obtained by printing from the negatives taken under the foregoing conditions were success or failure is shown in Table 3. Therein, the symbol S signifies success, while the symbol F signifies failure.

TABLE 3

| Sample | Picture-taking Condition | | | | | | | | | |
|---|---|---|---|---|---|---|---|---|---|---|
| No. | EV = 6.4 | EV = 7.4 | EV = 8.4 | EV = 9.4 | EV = 10.4 | EV = 11.4 | EV = 12.4 | EV = 13.4 | EV = 14.4 | EV = 15.4 |
| 101 | F | S | S | S | S | S | S | F | F | F |
| (Compar. | | | | | | | | | | |
| Example) | | | | | | | | | | |
| 102 | F | F | S | S | S | S | S | S | S | S |
| (Example 1) | | | | | | | | | | |
| 103 | F | F | S | S | S | S | S | S | S | S |
| (Example 2) | | | | | | | | | | |

Table 3 indicates the following. The present Samples 102 and 103 each having the light control system have substantial broadening of shooting-capable range with respect to the shooting under high illuminance conditions (great EV-value conditions), though they have somewhat narrowing of the shooting-capable range with respect to the shooing under low illuminance (small EV-value conditions), as compared with the comparative Sample 101 having no light control system, and ensure camera systems enabling picture-taking in comprehensively wider ranges.

### Example 3

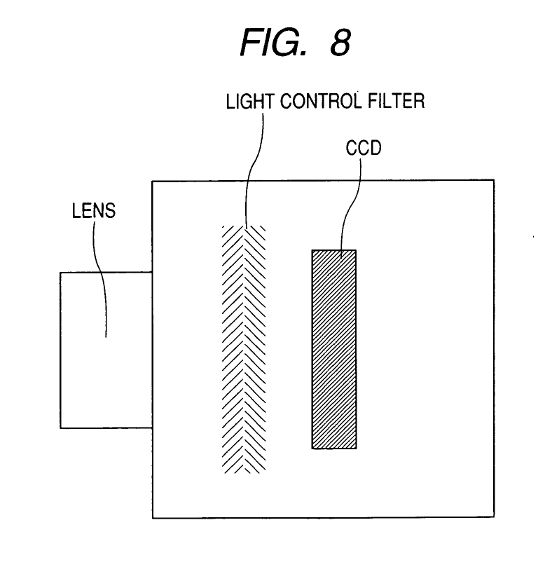

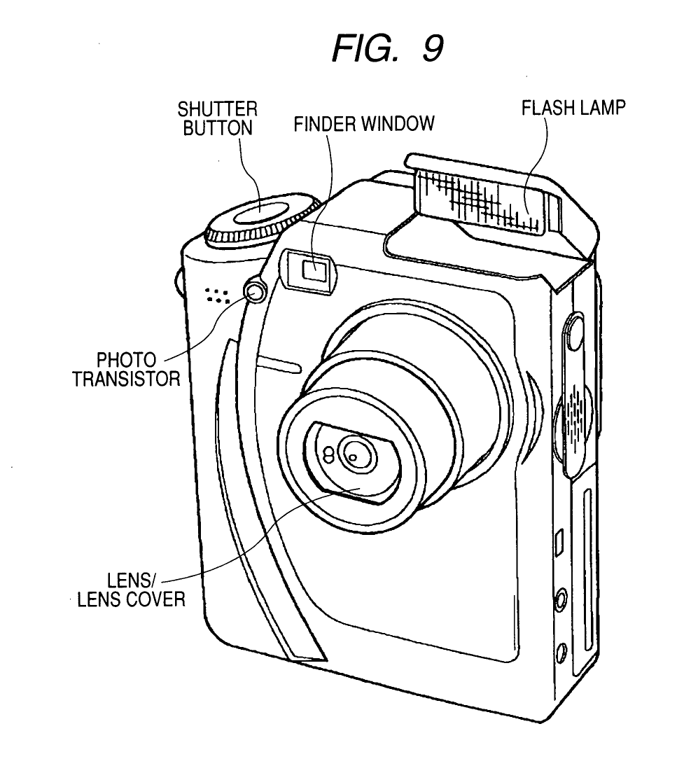

This example is an embodiment of the invention wherein the light control filter is installed in a still-video camera and a combination of a dry cell and a phototransistor is used as an electromotive-force generation element, and further a resistor is connected in parallel to the light control filter. The present still-video camera has, as shown in FIG. 8, the light control filter made in Example 1 between a lens and CCD, and further a small-sized phototransistor (RPM-075PT, made by Rohm Co., Ltd.) is placed on the exterior as shown in FIG. 9 and connected so that the light control filter is controlled by using as a power supply a battery (AA cell, 1.5V) built into the still-video camera. The resistance value of the resistor connected in parallel to the light control filter is 1.2 Ω. When the same comparative experiments as in the cases of the film with lens made in Examples 1 and 2 were conducted on the present still-video camera also, it was found that the invention achieved more remarkable light-controlling effects in the still-video camera having a narrow dynamic range than in the films with lens, as compared with their corresponding picture-taking units not having optical devices according to the invention. In addition, the risk of covering the solar cell with fingers was reduced.

### Example 4

This example is an embodiment of the invention wherein the light control filter is installed in a picture-taking unit for a mobile phone. The light control filter made in the same manner as in Example 1 was mounted on the lens of the picture-taking unit of a mobile phone, and further the same phototransistor as used in Example 3 was placed in the environs of the picture-taking unit and connected so that the light control filter was controlled by using as a power supply a battery built into the mobile phone. The mobile phone having the picture-taking unit as an embodiment of the invention enabled picture-taking under wider range of exposure conditions, as compared with the picture-taking unit not having an optical device according to the invention.

The invention is illustrated above in detail or by reference to the exemplary embodiments thereof, and it will be apparent to persons skilled in the art that many variations and modifications can be made without departing from the sprit and scope of the invention.

The present application is based on Japanese Patent Application (Tokugan 2004-144857) filed in May 14, 2004, and the entire disclosure of this Japanese patent application is incorporated herein by reference.

### Industrial Applicability

In accordance with the invention, a light control device that uses an electrochromic material capable of generating an electromotive force in response to the illuminance of, e.g., ultraviolet light or visible light is placed on the outside of the lens (on the subject side of the lens) or on the inside of the lens (on the imaging recording medium side of the lens) of a picture-taking unit, such as a film with lens, a still-video camera or a camera phone, and thereby the extension of a shooting-capable illuminance range is achieved.

1. A picture-taking unit comprising:
a taking lens; and
a light control device using an electrochromic material, on a subject side of the taking lens.

2. A picture-taking unit comprising:
a taking lens; and
a light control device using an electrochromic material, on an imaging recording medium side of the taking lens.

3. The picture-taking unit as described in claim 2, further comprising a shutter on the imaging recording medium side of the taking lens, wherein the picture-taking unit comprises the light control device on the imaging recording medium side of the shutter.

4. The picture-taking unit as described in claim 1, wherein the light control device comprises a nanoporous semiconductor material to which the electrochromic material is adsorbed.

5. The picture-taking unit as described in claim 1, wherein the light control device has an optical density of 0.2 or below at a wavelength of 400 nm when the light control device is in a discolored state.

6. The picture-taking unit as described in claim 1, wherein an average value of optical densities at wavelengths of 400 to 500 nm, an average value of optical densities at wavelengths of 500 to 600 nm and an average value of optical densities at wavelengths of 600 to 700 nm that the light control device has in a discolored state are all 0.1 or below.

7. The picture-taking unit as described in claim 1, which is a film with lens.

8. The picture-taking unit as described in claim 1, which is loaded with film having a high speed of ISO400 or above.
